(19) United States
(12) Patent Application Publication
(10) Pub. No.: US 2010/0120578 A1
(43) Pub. Date: May 13, 2010

(54) DRIVE AND STEERING CONTROL SYSTEM FOR AN ENDLESS TRACK VEHICLE

(76) Inventors: HICHEM BOUGUERRA, WATERLOO, IA (US); BRYAN DUGAS, NAPOLEONVILLE, LA (US)

Correspondence Address: DEERE & COMPANY, ONE JOHN DEERE PLACE, MOLINE, IL, 61265, US

(21) Appl. No.: 12/266,864

(22) Filed: Nov. 7, 2008

(51) Int. Cl. B62D 11/02

(52) U.S. Cl. 477/1; 180/6.2

(57) ABSTRACT

A drive and steering control system for an endless track vehicle such as a sugar cane harvester. A dual path hydrostatic drive has a pair of variable volume pumps connected for bidirectional flow to respective hydraulic motors driving a pair of endless tracks. A speed control lever and steering wheel mechanism each provide control inputs to a microprocessor which in turn controls the variable volume hydrostatic pumps to control vehicle velocity and turning in a way that matches control for wheeled vehicles. RPM sensors for the hydraulic motors provide a feedback signal that is used to compensate for equipment variation and to keep the vehicle on the course intended by the operator.

### FIELD OF THE INVENTION

The present invention relates to endless track vehicles and more specifically to drive and steering control systems for such vehicles.

### BACKGROUND OF THE INVENTION

The endless track vehicle has been in existence for over a century and has been applied to a wide variety of work machine situations. One such application is found in the harvesting of sugar cane. An endless track vehicle traverses the field and has a section severing the sugar cane and a section processing it for delivery to a hopper or second vehicle for carrying away for further processing. Traditionally, such harvesters have been controlled in the manner of endless track vehicles with separate levers, each controlling one of the tracks in terms of direction and rotational speed to propel the vehicle in a controlled manner at a selected speed. Another such control implementation is the use of a T-handle which has a pivoting movement to control speed and a rotational movement to control differential track RPM so as to change direction. A further implementation is the use of a so called “joy stick” that responds to forward movement for vehicle velocity control and side-to-side movement for turning movements.

While such control systems generally provide a way for an endless track vehicle to be controlled, they increase operator fatigue, particularly with respect to hand movements of the operator since the operator must compensate for variations in component manufacturing variations. Furthermore, there is a required learning curve for vehicle operators making a transition from traditional wheeled vehicles to endless track vehicles.

What is needed in the art therefore is an effective way to control endless track vehicles with a system that reduces operator fatigue and learning requirements.

### SUMMARY OF THE INVENTION

In one form, the invention is a drive and steering control system for an endless track vehicle. The system includes a pair of variable volume hydrostatic pumps respectively connected to a pair of hydraulic motors, each driving one of a pair of endless tracks for the vehicle. An operator controlled speed control mechanism is included for controlling forward and reverse velocity of the vehicle. A steering wheel is provided for manipulation by an operator to control direction of the vehicle and a controller receives inputs from the steering wheel and the speed control mechanism for controlling the RPM of the hydraulic motors to control the velocity and turning of the vehicle.

In another form, the invention is an endless track vehicle having a frame, a prime mover and a pair of endless tracks for ground movement. The prime mover drives a pair of variable volume hydrostatic pumps, respectively connected to a pair of hydraulic motors, each of which drives one of the endless tracks. A speed control mechanism is provided for controlling the forward and reverse velocity of the vehicle in response to an operator input. A steering wheel is mounted on the frame for manipulation by an operator to control turning of the vehicle. Finally, a controller receives inputs from the steering wheel and the speed control mechanism for controlling the RPM of the hydraulic motors to control the turning and velocity of the vehicle.

### BRIEF DESCRIPTION OF THE DRAWINGS

FIG. 1 is a perspective view of an endless track vehicle with a drive and steering control system embodying the present invention;

FIG. 2 is schematic view of the drive and steering control system for the endless track vehicle of FIG. 1; and

FIG. 3 is a graph showing the relationship between the steering wheel inputs and differential track speed for different operating conditions of the vehicle of FIG. 1.

### DETAILED DESCRIPTION OF THE INVENTION

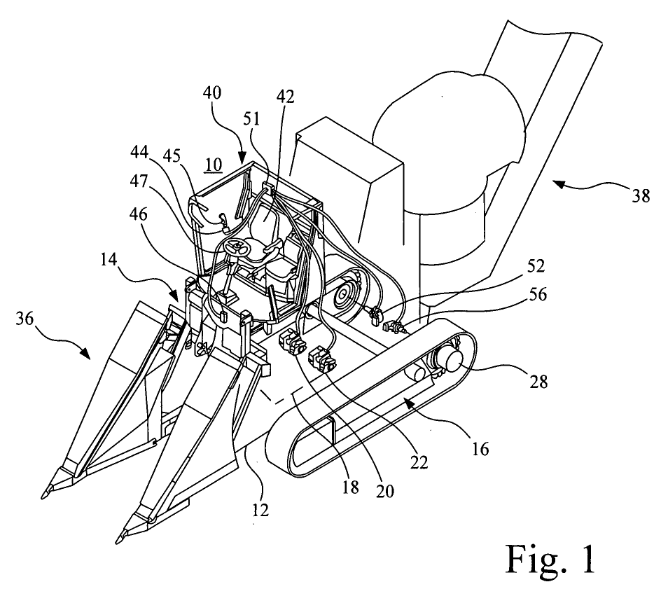

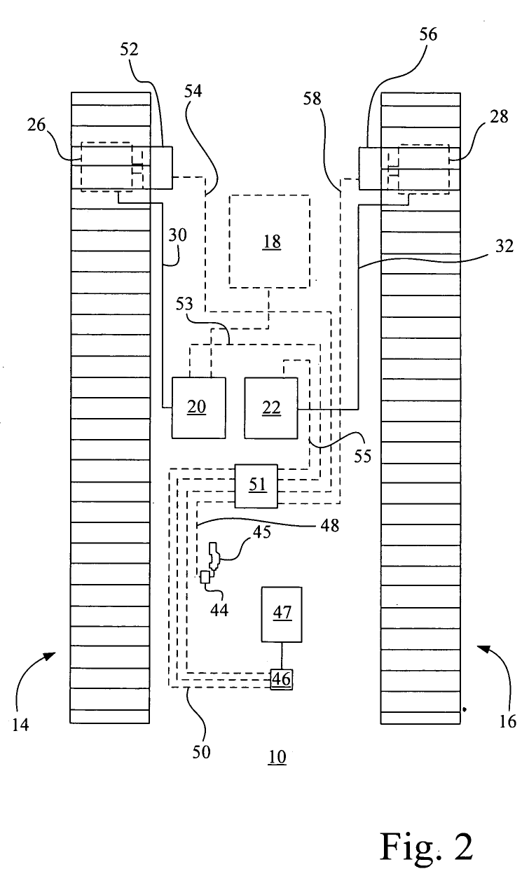

Referring now to FIGS. 1 and 2, there is shown an endless track vehicle 10 having a frame 12 for mounting a pair of endless track assemblies 14 and 16 on opposite sides of the frame 12. A prime mover 18, usually in the form of a compression ignition or diesel engine, is used to provide propulsion for the vehicle 10 and various agricultural processing functions. The prime mover 18 is connected to a variable volume dual path hydrostatic pump assembly comprising first pump 20 and second pump 22. The variable volume hydrostatic pumps 20 and 22 are respectively connected to hydraulic motors 26 and 28 respectively driving endless track assemblies 14 and 16. The variable volume hydrostatic pump 20 is connected to motor 26 for bidirectional flow of fluid through a pair of conduits 30. Thus, pump 20 can operate hydraulic motor 26 in a forward, neutral and reverse direction with variable RPM. Pump 22 is connected to motor 28 by a pair of conduits 32 and also permits variable volume bidirectional flow to control the RPM of motor 28.

A harvesting mechanism 36 is provided at the forward end of vehicle 10. This mechanism may take many forms depending upon the function required. For example, for sugar cane the mechanism 36 would be a mechanism that gathers and severs the sugar cane for further processing, not shown to enable a clearer understanding of the invention. A further mechanism 38 may be provided for delivering the harvested material either to a storage container or to an additional vehicle used to carry the sugar cane away.

An operator control cab 40 is provided at the forward end of vehicle 10 and includes an operator seat 42 and vehicle speed control mechanism 44. The speed control mechanism may take the form of a number of control inputs such as a dual output propulsion potentiometer controlled by an operator lever 45. A steering wheel mechanism 46 is provided for operator manipulation. Steering wheel mechanism 46 may be in many forms but in the usual form it provides a steering wheel 47 and a control mechanism to provide control inputs as described below. The steering wheel mechanism 46 is mechanically centered in a straight ahead direction usually using some form of bidirectional yieldable urging so that without an input the steering wheel is urged to a center, or neutral position.

The speed control mechanism 44 and steering wheel mechanism 46 provide signal inputs via lines 48 and 50 to a microprocessor 51. Microprocessor 51 receives control inputs from the speed control mechanism 44 and steering wheel mechanism 46 to send signals via lines 53 and 55 to pumps 20 and 22 to vary the volume and thus the speed and direction of the endless tracks 14 and 16. In a usual fashion, the control input provided by connections 53 and 55 is to manipulate a variable swash plate, although many other inputs may be employed. The RPM of the motors 26 and 28, and thus the endless track speed is sensed by sensors 52 and 56 and fed back to microprocessor 51 by lines 54 and 58 respectively. Thus, the actual RPM of motors 26 and 28 is fed back to microprocessor 51 for manipulation in the manner described below.

The propulsion and steering control system includes the three sensor steering input device 46 mechanically centered and coupled to the standard steering wheel 47, a dual output propulsion potentiometer as the main forward/reverse ground drive speed input mechanism 44, the microprocessor 51 and individual RPM sensors 52 and 56 for feedback from the final drive motors. The disclosed steering system permits use of a standard steering column/wheel mechanical input for steering and a separate propulsion input for propelling forward or reverse.

The forward/reverse speed control system is a closed loop control. The desired speed command is generated from the speed control mechanism 44. Mechanically linked to the input handle 45 is a propulsion potentiometer sensor. A dual output potentiometer with a main signal and redundant secondary signal is integrated into the system.

The feedback signal is the average ground speed measured from both motors 26 and 28. The microprocessor 51 uses redundant input sensors and output drivers for improved reliability and operator safety. In the event a speed sensor feedback signal is lost, the microcontroller will alert the operator, via a diagnostic trouble code and immediately switch to open loop control of the propulsion and steering system. The speed sensors 52 and 56 provide the control system with speed and direction inputs. Any residual error between the left and right tracks ground speed is used to further close the loop on each side to match speeds and achieve straight tracking.

The steering input mechanism 46 measures the rotational position of steering wheel 47. The device has fixed end-stops with 560 degrees of rotational lock to lock (280 degrees each direction from the spring centered position). The steering input mechanism 46 includes a self-centering mechanical spring, has a positive feel at the center, and requires low effort to steer. Three identical steering wheel position sensors provide redundancy from the steering wheel 47 to the steering control mechanism 46.

A closed loop control strategy is used to control the speed and steering of the vehicle 10 and consists of an inner loop to individually control the speed of each side of the tracks 14 and 16. An outer loop, speed tracking will monitor the differential speed between both sides of the tracks, compares the error with the steering command and feedbacks the result proportionally to each side in such a way that one side of the tracks speeds up and the other slows down.

In manual mode, steering of the vehicle to a desired turn radius is achieved by generating a variable ratio steering command based on the steering wheel position and vehicle speed. The steering command is added to the speed command so that one track is sped up and the other slowed down so that forward/reverse ground speed is maintained. For vehicles equipped with Global Position Systems (GPS), the control system uses position and course information of the vehicle to calculate a track course error and a lateral error and generate the proper steering command to guide the vehicle along predefined parallel tracks.

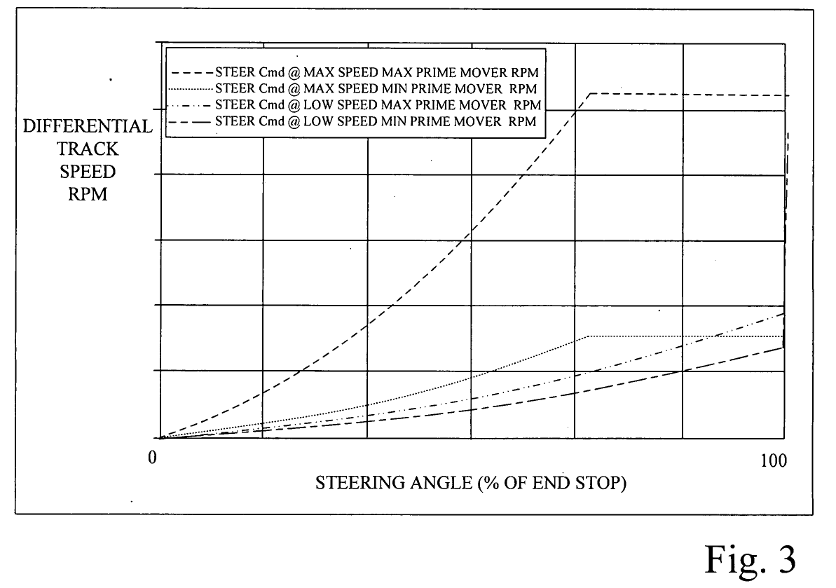

FIG. 3 illustrates the correlation between steering wheel postion and the relative speed of the motors 26 and 28. In general, the vehicle 10 turn radius and direction of turn is a function of steering wheel 47 angular position, wheel RPM, engine RPM, and direction of travel. Changing direction of travel maintains the original turn radius. Steering action is reduced but not eliminated when the vehicle stops and a park brake is not engaged. A transitional counter rotation mode is built into the steering algorithm to prevent sudden steering from occurring when a park brake is disengaged while the steering wheel is not at the spring centered and the vehicle is stationary.

Another mode of steering referred to as the “endstop ramp” is also built into the steering algorithm in order to allow the operator maximum turning rate while maintaining fine steering around the spring centered position, the gain curve is extended by utilizing a ramping function when the operator is at the steering wheel endstops. The ramp rate is proportional to vehicle speed/engine RPM. In stationary counter rotation mode it is proportional to engine speed. The graph illustrates the maximum and minimum steering curves due to changes in engine speed and vehicle speed.

The feedback signal from the sensors 52 and 56 is fed back into the microprocessor 51 to provide a closed loop system in which the motors actually rotate at the commanded signal. This compensates for manufacturing variations between the pumps. The residual error between the left and right tracks is thus corrected to achieve a straight tracking which is particularly important for minimizing operator fatigue.

The turning of the vehicle is a function of the position of steering wheel 47 and that signal via line 50 overlays the speed signal from line 48 to produce differential controls at pumps 20 and 22 as a function of the wheel angular position, the engine speed, track speed and direction of travel. By using a standard steering wheel 47, the need for special operator adjustment to the standard drive for a tracked vehicle is avoided.

Having described the preferred embodiment, it will become apparent that various modifications can be made without departing from the scope of the invention as defined in the accompanying claims.

1. A drive and steering control system for an endless track vehicle, said system comprising:
a pair of variable volume hydrostatic pumps respectively connected to a pair of hydraulic motors, each driving one of a pair of endless tracks for said vehicle;
an operator manipulated speed control mechanism for controlling forward and reverse velocity of said vehicle;
a steering wheel for manipulation by an operator to provide a signal for controlling turning of said vehicle; and
a controller receiving inputs from said steering wheel and said speed control mechanism for controlling the RPM of said hydraulic motors to control the turning and velocity of said vehicle.

2. The drive and steering control system as claimed in claim 1 further comprising a sensor connected to and generating a signal for the RPM of said motors to feed back the RPM signal to said controller for correcting between the desired RPM and actual RPM.

3. The drive and steering control system as claimed in claim 1 wherein said controller is a microprocessor.

4. The drive and steering control system as claimed in claim 1 wherein said steering wheel is mechanically urged towards a central position.

5. The drive and steering control system as claimed in claim 3 wherein speed control mechanism includes a potentiometer generating said signals.

6. The drive and steering control system as claimed in claim 3 further comprising at least one sensor for providing the position of said wheel, said sensor providing a signal to said microprocessor.

7. The drive and steering control system as claimed in claim 3 further comprising a sensor connected to and generating a signal for the RPM of said motors to feed back the RPM signal to said microprocessor for correcting between the desired RPM and actual RPM.

8. The drive and steering control system as claimed in claim 3 wherein the steering differential RPM between said motors is increased at adjacent the limits of the steering wheel travel.

9. A vehicle comprising:
a frame;
a pair of endless tracks carried by said frame for providing ground movement of said vehicle;
a prime mover;
a pair of variable volume hydrostatic pumps driven by said prime mover;
a pair of hydraulic motors each driving one of said endless tracks for said vehicle, said pumps being connected to said hydraulic motors for variable bidirectional flow to thereby control the RPM of said motors and the velocity generated by each of said track;
a speed control mechanism for generating a signal controlling the forward and reverse velocity of said vehicle;
a steering wheel for manipulation by an operator to control turning of said vehicle in response to control signals; and
a controller receiving control inputs from said steering wheel and said speed control mechanism for controlling the RPM of said hydraulic motors to control the turning and velocity of said vehicle.

10. The vehicle as claimed in claim 9 further comprising a sensor connected to and generating a signal for the RPM of said motors to feed back the RPM signal to said controller for correcting between the desired RPM and actual RPM.

11. The vehicle as claimed in claim 9 wherein said controller is a microprocessor.

12. The vehicle as claimed in claim 9 wherein said steering wheel is mechanically urged towards a central position.

13. The vehicle as claimed in claim 11 wherein speed control mechanism includes a potentiometer generating said signals.

14. The vehicle as claimed in claim 11 further comprising at least one sensor for providing the position of said wheel, said sensor providing a signal to said microprocessor.

15. The vehicle as claimed in claim 11 further comprising a sensor connected to and generating a signal for the RPM of said motors to feed back the RPM signal to said microprocessor for correcting between the desired RPM and actual RPM.

16. The vehicle as claimed in claim 11 wherein the steering differential RPM between said motors is increased at adjacent the limits of the steering wheel travel.
